(19) United States
(12) Patent Application Publication
(10) Pub. No.: US 2007/0240048 A1
(43) Pub. Date: Oct. 11, 2007

(54) A STANDARD COMMUNICATION INTERFACE FOR SERVER-SIDE FILTER OBJECTS

(75) Inventors: Michal K. Piaseczny, Bellevue, WA (US); Christopher M. McKulka, Woodinville, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/278,390

(22) Filed: Mar. 31, 2006

(51) Int. Cl. G06F 3/00

(52) U.S. Cl. 715/700

(57) ABSTRACT

A filter object comprising a standard sending interface consumed from an object framework to send at least one filter value to at least one consumer object supported by the object framework and a user interface to allow a user to configure a connection between the filter object and a consumer object. A developer may create a consumer object with a receiving interface such that the consumer object may accept filter values in order to filter the data it may display to a user. However, a filter developer may create a filter object with a sending interface such that the filter object may send a filter value to consuming objects that implement a similar receiving interface. If the consumer object does not implement a receiving interface compatible with the filter object, the consumer object may not be able to receive filter values from the filter object. A server-side object framework implementing a standard communication interface may allow a filter object consuming a standard sending interface and a consumer object consuming a standard receiving interface to communicate.

### BACKGROUND

A typical network used by employees of a business may include a world wide web site displaying markup language documents that may include information related to the business. Markup language documents on the world wide web site may include a reference to a server-side data display object that may display business data to the user in a visual manner. A user of the world wide web site may wish to further filter the data displayed by the display object to prevent irrelevant data from being displayed. A markup language document may include a reference to a server-side filter object that displays a user interface to a user allowing the user to select a filter value. The server-side filter object and the server-side data display object may have functionality allowing the filter object to send the filter value to the display object.

If the server-side filter object and the server-side data display object consume a similar data communication interface, the server-side filter object may send a value to the server-side data display object such that the server-side data display object may filter the data displayed by the data display object. However, if the server-side filter object and the server-side data display object do not consume a similar communication interface, no communication may be possible. A user may not be able to filter the business data displayed on the world wide web site.

### DESCRIPTION OF THE DRAWINGS

The present description will be better understood from the following detailed description read in light of the accompanying drawings, wherein:

FIG. 1 is a block diagram showing a client PC connected to a server PC by a network, the client PC executing a browser application and the server PC executing a markup language document server including server-side executable objects consuming non-standard interfaces.

FIG. 2 is a block diagram showing a client PC connected to a server PC by a network, the client PC executing a browser application and the server PC executing a markup language document server including a connection object and server-side executable objects consuming standard interfaces.

FIG. 3 is a block diagram showing a client PC connected to a server PC by a network, the client PC executing a browser application and the server PC executing a markup language document server including a connection object and server-side executable objects consuming standard interfaces.

FIG. 4 is a flow diagram showing an example method for configuring a connection between an example filter object and an example filter consumer object.

FIG. 5 is a flow diagram showing an example configuration method.

FIG. 6 is a flow diagram showing an example sending network object reporting method.

FIG. 7 is a flow diagram showing a method to automatically configure at least one connection within an example network objects framework.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a Server Personal Computer (PC) system, the system described is provided as an example and not a limitation. As those skilled in the art will appreciate, the present examples are suitable for application in a variety of different types of systems including a conventionally constructed Personal Computer (PC) intended for use in the home, Personal Digital Assistants (PDAs), portable telephones, consumer electronics devices including media players, virtualizations or emulations of Server PCs or home PCs, and the like.

This description relates generally to a system including example functionality which may allow the connection of server-side filter provider objects and server-side filter consumer objects using standard interfaces and additional functionality which may be allowed by the use of standard interfaces. More particularly, a server on a network such as the Internet may store markup language documents such as hypertext markup language (HTML) documents. An author may create a markup language document and store it on the server. A client on the network may use an application, such as an internet browser, to send a request to the server to send the markup language document to the client. The client application may include functionality to convert the markup language document to a human-readable format. This functionality is also known as rendering a markup language document.

The application may establish a session with the server such that the server stores information related to the address of the client, the time the client first connected to the server, and the like. A session may allow the server to maintain state information related to the rendered markup language document on the client such that the markup language document may contain instructions to render user interface elements such as buttons and other types of user interface controls. Such buttons and user interface controls may create events which are sent to the server during the duration of the session. The server may then act in accordance with the sent events and in return send a newly created markup language document to the client.

For example, the user may use an application to begin a session with the server by requesting a markup language document. The server may then locate the markup language document and send it to the client application. The client may then render the markup language document, and the rendered page may include a button which, when pushed by the user, submits a request to the server to change an aspect of the markup language document. The server may then receive the button press event informing the server of the user's instruction to change an aspect of the markup language document. The server may then act in accordance with the event using information stored corresponding to the session and return a markup language document reflecting the change instructed by the user.

Further, a markup language document may include references to computer executable objects which may execute in conjunction with the client application. For example, a client application such as Microsoft Internet Explorer® may include functionality to execute an ActiveX® control. The client application may instantiate the reference objects and display information to the user when the client application renders the markup language document. For example, a markup language document may include a reference to a data display object and the address of a database containing a set of data to be displayed. The client application may instantiate the data display object and may pass the location of the database and any additional data references to the data display object. The data display object may make use of the display functionality of the client application to display a table containing the referenced data. Such objects may be called client-side objects.

Such functionality may allow a greater range of content to be displayed by markup language documents. However, not all clients may share a common level of performance and not all clients may be able to execute such objects. A server computer may typically have a higher level of performance than a client and may execute computer executable objects that generate markup language representing a user interface on behalf of the client. The server may send the generated markup language to the client such that the user may interact with the generated markup language. In addition, a server may have access to resources on the network that are inaccessible to the client due to security or other reasons. In this case, the server may have higher security access than the client and may act as a proxy for the client. For example, a data access object executing on the server may have security privileges such that the data access object may retrieve data from a secure database, create markup language representing a table populated with the retrieved data, and send the markup language to the client. Such objects executing on the server may be called server-side objects.

Such server-side objects may execute in conjunction with a session to store and process information in a complex manner. The server may maintain complex information within a hierarchy of server-side objects in conjunction with client session information to allow complex types of user interaction. In addition, the server may execute a runtime environment including compilation services such that markup language documents stored on the server may contain uncompiled computer code or script that may be compiled to create objects for execution in the runtime environment when the markup language document is requested by a client.

Such functionality on the server may be powerful but may also make the task of creating markup language documents more difficult or cumbersome for a markup language document author in creating a collection of markup language documents. Such a collection of markup language documents may be referred to as a site or a portal. It may be useful to markup language document authors for a software developer to create a set of template markup language documents that reference a corresponding set of server-side objects. The markup language document author then may add written content to the template markup language documents and easily create an entire website or portal. In addition, the server-side objects may be created in such a way as to allow a user of a client to modify the appearance of the template markup language documents. The server may store the user's preferences with regard to the appearance of the template markup language documents, thereby allowing a user of the site or portal to have an opportunity to author part of the site or portal without requiring the user to have knowledge of the markup language or the server-side objects. An example of such a system may be Microsoft Sharepoint Services®.

Such template markup language documents may further help a user to configure the markup language documents by including specific areas, or zones, intended to display specific types of user interfaces from server-side controls. For example, the template markup language document may include an area intended to display dynamically updating news information such as a stock ticker. More particularly, such sites or portals may be directed to specific types of business situations. For example, a business may implement such a site or portal for use by users with different roles within the company and as such may require that the pages viewed by each user include different types of information. For example, a user in the sales department may view sales information while a user in the technical department may view technical information.

In such a business application, it may be useful for a specific type of user to further filter information displayed by a markup language document included in the portal or site. A server-side filter object may display a user interface on the client such as a drop-down list or a text entry box and allow the user to select a value which may be sent to a server-side display object. The server-side display object may then filter the data to be displayed using the filter value. For example, the user may be presented with a filter drop-down list on the client that is populated with a list of all states included in the United States. Initially, a data display object on the client may display sales information from all states. When the user selects a state, for example Washington State, and clicks an “apply” button on the client, that information is sent to the server. The server receives the event and the filter value of “Washington State”. The server may then pass the filter value “Washington State” to the server-side display object, and the server-side display object may remove all data entries in the user interface that do not correspond to sales in Washington State. The server may then send the resulting markup language generated by the server-side display object back to the client.

Not all server-side filter objects may be developed by the same developer. In such an instance, a server-side filter object and a server-side display object may not include functionality to communicate. For example, a developer of a server-side filter object may only implement functionality such that the server-side filter object is only able to communicate with server-side display objects from the same developer. A developer of a different server-side display object may not be able to receive filter values from such a server-side filter object.

However, the portal or site and the server-side objects corresponding to the portal or site may implement a standard communication method for server-side filter objects and server-side display objects. Such a standard communication method may allow most server-side filter objects and most server-side display objects to communicate. Such a standard communication interface may provide additional functionality to server-side filter objects and server-side display objects.

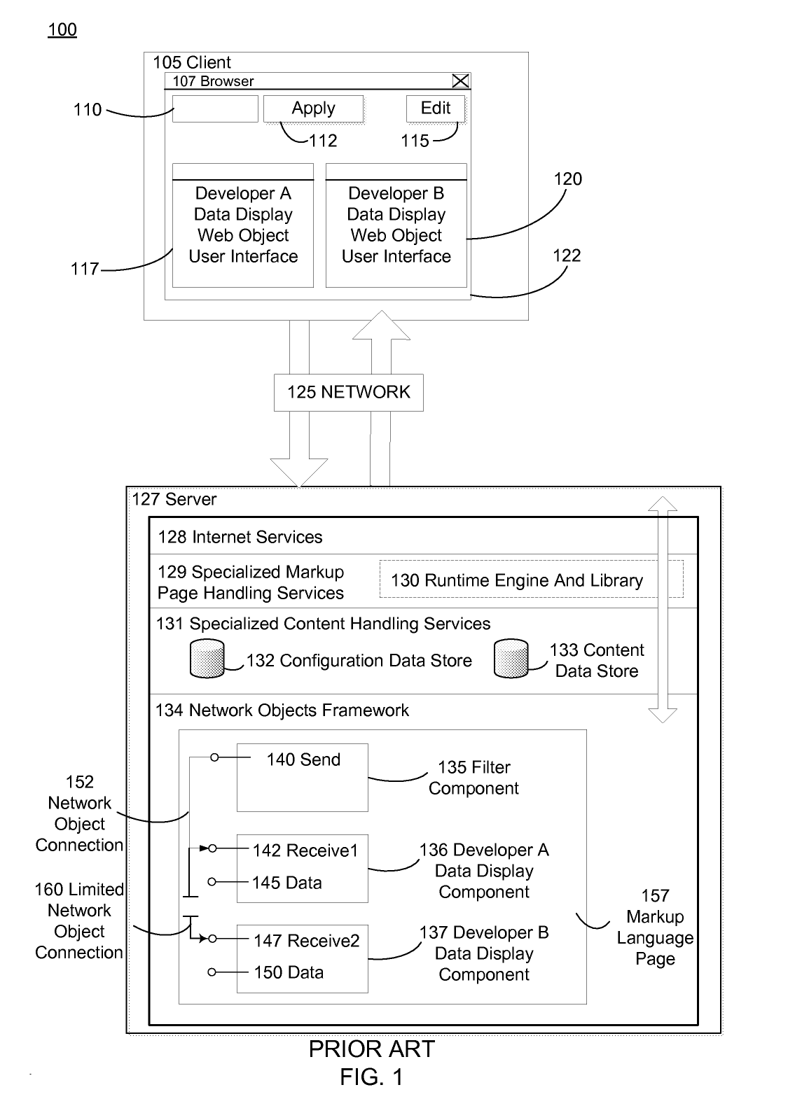

FIG. 1 is a block diagram showing a conventional client PC 105 connected to a conventional server PC 127 by a conventional network 125, the conventional client PC 105 executing a conventional browser application 107 and the conventional server PC 127 executing a conventional internet server 128. The conventional internet server 128 may include a conventional server-side filter object 135, a server-side data display object from a first developer 136, and a conventional server-side data display object from a second developer 137.

Each of the client PC 105 and server PC 127 may be conventionally constructed computers typically including a central processing unit (CPU), persistent and non-persistent memory storage such as a conventional random access memory (RAM) and a conventional hard disk, conventional input and output devices such as a video graphics card and a keyboard, and a conventional operating system which may typically provide functionality for typical operation of each of the client PC 105 and the server PC 127.

The conventional server PC 127 may typically execute a conventional internet server 128. A conventional internet server 128 may typically execute services to respond to requests received by the conventional server PC 127. Such services may include instructions to receive and respond to messages sent using the hypertext transfer protocol (HTTP). An example of such conventional internet server 128 may be Microsoft Internet Information Server (IIS). Other conventional services may be further implemented in conjunction with the internet server 128 which may add functionality to the conventional internet server 128.

For example, the conventional internet server 128 may include conventional specialized markup language page handling services 129. Such conventional specialized markup language page handling services 129 may provide services to allow code or scripts stored in specialized markup language documents to be compiled and executed by the conventional internet server 128 before the document is sent to the conventional client PC 105. An example of such a conventional specialized markup language page handling services 129 may be Microsoft Active Server Pages.

Further, because the conventional specialized markup language page handling services 129 may include functionality to compile and execute code and scripts, the conventional specialized markup language page handling services 129 may further include a conventional runtime engine and libraries 130. A conventional runtime engine and libraries 130 may provide conventional runtime functionality such as multiple programming language support, just-in-time compilation, computer code reuse through object and object inheritance, memory management, and the like. The conventional runtime engine and libraries 130 may also include a set of objects which may implement conventional input and output functionality, data access functionality, standard type collections, and the like. Such libraries may serve as the foundation computer code that other applications executing in the conventional runtime engine and libraries 130 may reuse. An example of such a conventional runtime engine and libraries 130 may be the Microsoft Common Language Runtime (CLR) and .Net Frameworks.

The conventional internet server 128 may further include conventional specialized content handling services 131. Such conventional specialized content handling services 131 may provide services derived from the conventional specialized markup language page handling services 129 and may allow the installation and implementation of a collection of user configurable markup language documents. An example of such conventional specialized content handling services 131 may be Microsoft Windows® Sharepoint Services® (WSS). For example, conventional specialized content handling services 131 may store a set of conventional configurable markup language documents in a conventional content data store 133. The configurable markup language documents stored in the conventional content data store 133 may have been created to facilitate communication between groups of users with common interests or business functions. In addition, the conventional specialized content handling services 131 may further include objects including instructions to store, open, and display documents other than conventional markup language documents such as conventional spreadsheet documents or conventional word processing documents such that a group of users may collaborate on business documents of this type using conventional specialized content handling services 131.

In particular, conventional specialized content handling services 131 may further include objects or modules including computer code or scripts intended for the creation of conventional modular user interface objects which may include conventional user configurable user interface elements. Conventional specialized content handling services 131 may include functionality such that conventional modular user interface objects may be selected from a list on a conventional configurable markup language document, then dragged and dropped into a compatible location or zone included in the conventional configurable markup language document. Once the selected conventional modular user interface object has been added to the conventional configurable markup language document, a user of the conventional configurable markup language document may configure any configurable properties of the conventional modular user interface object. The configuration of such conventional modular user interface object may be stored by the conventional specialized content handling services 131 in a conventional configuration data store 132. An example of such a conventional modular user interface object may be Windows® Sharepoint Services® (WSS) Web Parts.

More particularly, a conventional network objects framework 134 may implement a set of conventional specialized modular user interface objects, for example a conventional server-side filter object 135, a conventional server-side data display object from a first developer 136, and a conventional server-side data display object from a second developer 137. The conventional network objects framework 134 may be included in the conventional internet server 128. Further, the conventional network objects framework 134 may derive services, computer code, objects, or the like from both conventional specialized content handling services 131 and conventional specialized markup language page handling services 129.

Such conventional specialized modular user interface objects may consume communication interfaces exposed by the conventional network objects framework 134. The exposure of interfaces and consumption of interfaces is an aspect of object-oriented programming that may be known to those of skill in the art. The conventional server-side filter object 135 may consume a conventional send interface 140 in order to send filter values to a consumer. The conventional server-side data display object from a first developer 136 may implement a conventional first receive interface 142 and may also include or implement a conventional first data interface 145 through which the conventional server-side data display object from a first developer 136 may receive data. Such a conventional first data interface 145 may use data access objects or services implemented in the conventional internet server 128, the conventional specialized markup language page handling services 129, the conventional specialized content handling services 131, or the like. The conventional server-side data display object from a second developer 137 may implement a conventional second receive interface 147 and may also include or consume a conventional second data interface 150. Such a conventional second data interface 150 may use data access objects or services implemented in the conventional internet server 128, the conventional specialized markup language page handling services 129, the conventional specialized content handling services 131, or the like.

A conventional markup language document 157 may be stored in a storage location included in the conventional server PC 127. The conventional markup language document 157 may include a reference to the conventional server-side filter object 135, or may include a reference to the conventional server-side data display object from a first developer 136, or may include a reference to the conventional server-side data display object from a second developer 137, or the like. The conventional markup language document 157 may be processed by the conventional internet server 128, the conventional specialized markup language page handling services 129, the conventional specialized content handling services 131, or the like.

During example processing, the conventional specialized content handling services 131 may retrieve information regarding the configuration data for each of the conventional server-side filter object 135, conventional server-side data display object from a first developer 136, and conventional server-side data display object from a second developer 137. Such configuration data may be represented by a conventional network object connection 152 and a conventional connection with limited capabilities 160. For example, the conventional server-side filter object 135 may share a common communication interface with the conventional server-side data display object from a first developer 136 and therefore a conventional network object connection 152 may be possible. However, the conventional server-side data display object from a second developer 137 may not share a common communication interface with the conventional server-side filter object 135 and therefore a conventional connection with limited capabilities 160 may be the result.

The conventional markup language document 157 may be requested by a user of the conventional client PC 105. Such a conventional markup language document 157 may be sent from the conventional server PC 127 over the conventional network 125 to the conventional client PC 105 such that the conventional browser application 107 may render the conventional markup language document 157 to produce the conventional rendered markup language document 122. The conventional rendered markup language document 122 may include a conventional filter user interface control 110, a conventional apply button user interface control 112, a conventional edit button user interface control 115, a conventional data display user interface control from a first developer 117, and a conventional data display user interface control from a second developer 120.

More particularly, the conventional filter user interface control 110 may correspond to the conventional server-side filter object 135, the conventional data display user interface control from a first developer 117 may correspond to the conventional server-side data display object from a first developer 136, and the conventional data display user interface control from a second developer 120 may correspond to the conventional server-side data display object from a second developer 137.

The conventional edit button user interface control 115 may allow a user of the conventional client PC 105 and the conventional browser application 107 to edit one or more aspects of the conventional rendered markup language document 122. Such functionality may be included with the functionality provided by the conventional specialized content handling services 131. Once the user presses the conventional edit button user interface control 115, the user may be presented with a dialog box or the like that may provide functionality to configure the conventional rendered markup language document 122. Once the user has finished configuring the conventional rendered markup language document 122, the user's configuration information may be saved to the conventional configuration data store 132.

During such an editing procedure, the user may configure the conventional filter user interface control 110 and the conventional server-side filter object 135 that may correspond to the conventional filter user interface control 110. Such a configuration may involve selecting a consumer of the filter value entered into the conventional filter user interface control 110. Such a consumer of the conventional filter user interface control 110 may be the conventional data display user interface control from a first developer 117, the conventional data display user interface control from a second developer 120, or the like. However, the conventional server-side filter object 135 and the conventional server-side data display object from a second developer 137 may be connected by a conventional connection with limited capabilities 160 due to the incompatibility of the conventional send interface 140 consumed by the conventional server-side filter object 135 and the conventional second receive interface 147 consumed by the server-side data display object from a second developer 137. Therefore, the conventional filter user interface control 110 may not be capable of sending a filter value to the conventional data display user interface control from a second developer 120 when the conventional markup language document 157 is processed on the conventional server PC 127.

A network objects framework that implements a common communication interface for a sending object and a receiving object may be helpful in allowing server-side objects to communicate.

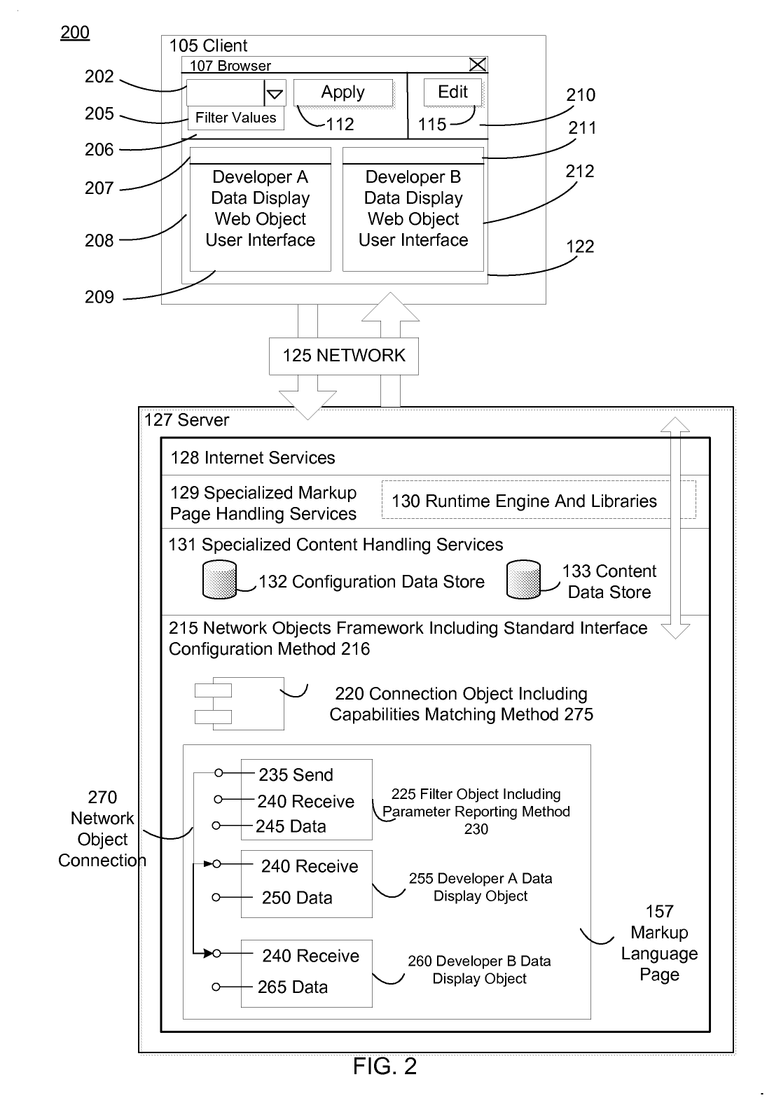

FIG. 2 is a block diagram showing a client PC 105 connected to a server PC 127 by a network, the client PC 105 executing browser application 107 and the server PC 127 executing an internet server 128, specialized markup language page handling services 129, specialized content handling services 131, and a network objects framework 215. The network objects framework 215 may include a connection object 220 and server-side executable objects consuming standard interfaces.

Such a network objects framework 215 may further include a standard interface configuration method 216. The network objects framework 215 may implement a set of standard communication interfaces, for example a standard send interface 235, a standard receive interface 240, or the like. A network object that consumes these standard interfaces may communicate using a network object connection 270. An example of a network object may be a filter network object 225, a data display object from a first developer 255, a data display object from a second developer 260, or the like. In the case where a first network object may send a value that must be processed before it may be consumed by a second network object, it may be useful for the network objects framework 215 to instantiate a connection object 220 that may further translate or transform information sent from a first network object and a second network object.

The components having like numbering from the previous figure function similarly, and the reader is directed to the previous figure for a description of their operation. A description of the newly introduced components is provided below.

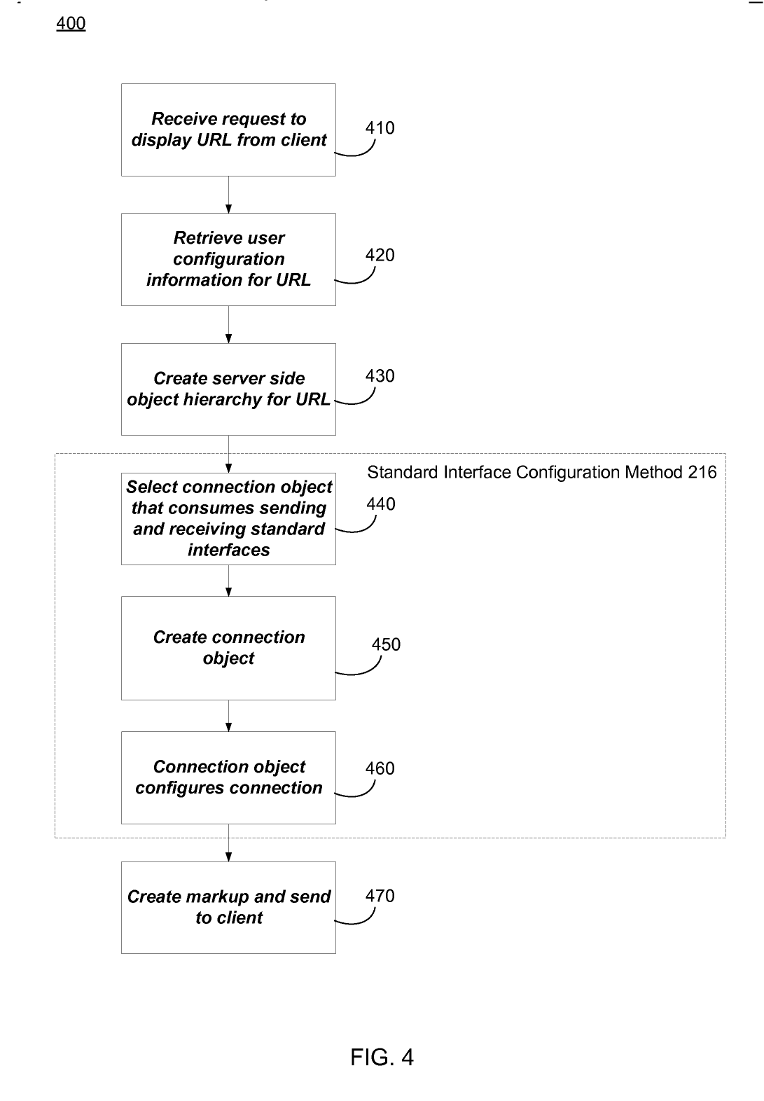

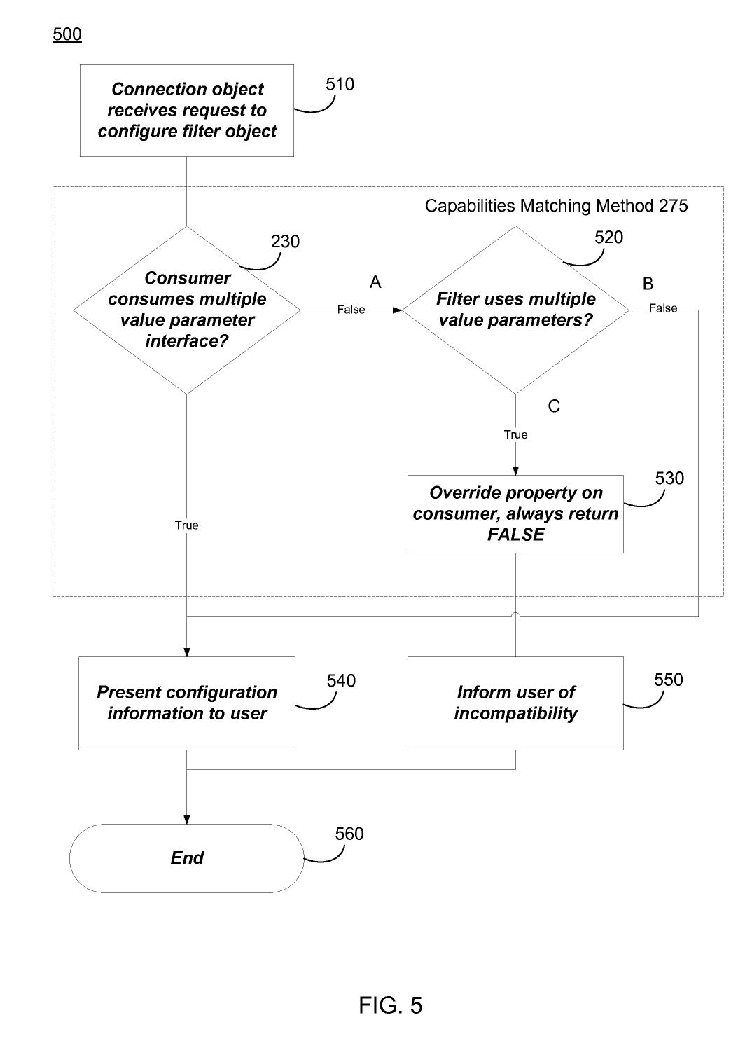

Developers wishing to create network objects for use in the network objects framework 215 may derive their network objects from a set of classes, objects, or the like implemented in the network objects framework 215. In creating network objects from the network objects framework 215, developers may access functionality implemented in the network objects framework 215. An example of such functionality may be a parameter reporting method 230. In addition, the network objects framework 215 may further instantiate a connection object 220 that may facilitate communication between different network objects by translating or transforming information sent between network objects. A connection object 220 may be instantiated as a result of standard interface configuration method 216 that will be discussed in FIG. 4. The connection object 220 may implement a capabilities matching method 275 to determine the type of translation or transformation. The capabilities matching method 275 will be discussed in FIG. 5.

The network objects framework 215 may send a markup language document 157 to the client PC 105 such that the rendered markup language document 122 may include a first markup language document zone 206, a second markup language document zone 210, a third markup language document zone 208, and the like. Such markup language document zones may be derived from a document template stored in the specialized content handling services 131. The code or scripts containing in the markup language document 157 from which the rendered markup language document 122 was rendered may allow only certain types of network objects to be included in certain zones for the purposes of providing a consistent markup language document template.

For example, the first markup language document zone 206 may have been implemented such that only a filter user interface control and a corresponding button, for example a filter user interface control 202 including one or more filter values 205 and an apply button user interface control 112, may be placed there. By including such a restriction for the zone, an author of the markup language document 157 may ensure the basic layout of the rendered markup language document 122 remains as the author intended. However, the author may still provide the user with an opportunity to configure the markup language document using the edit button user interface control 115. Further, the second markup language document zone 210 may have been implemented such that only an edit button user interface control, for example the edit button user interface control 115, may be placed there. In addition, the third markup language document zone 208 may have been implemented such that only a data display user interface control may be placed there. An example of a data display user interface control may be a data display user interface control from a first developer 209, a data display user interface control from a second developer 212, or the like.

The filter user interface control 202 may have a user interface provided by the filter network object 225. The network objects framework 215 may provide a standard send interface 235 and a standard receive interface 240 that may each be consumed by the filter network object 225. The filter network object 225 may further implement or consume a standard data interface 245 which may be implemented in any of the internet server 128, specialized markup language page handling services 129 including the runtime engine and libraries 130, the specialized content handling services 131, or the like. Such a standard data interface 245 may provide data access functionality to the filter network object 225 such that the filter network object 225 may receive data values from a data source connected to the server PC 127. The filter network object 225 may use the received data to populate the filter values 205 such that when the user interface for the filter network object 225 is rendered, a user may select one of the filter values 205 to send to a consumer network object.

Such a consumer of the filter values 205 may be a data display user interface control from a first developer 209, a data display user interface control from a second developer 212, or the like. A user may configure the consumer network object of the filter user interface control 202 by pressing the edit button user interface control 115 and editing the configuration using a user interface provided by the internet server 128, specialized markup language page handling services 129, specialized content handling services 131, network objects framework 215, or the like.

The network objects framework 215 may further provide functionality to network objects derived from classes or objects included within the network objects framework 215 such that the network objects may further include a user interface element which displays configuration information. For example, the data display user interface control from a first developer 209 may include a configuration information bar 207. In an alternative example, the data display user interface control from a second developer 212 may also include a configuration information bar 211. The information displayed by such a configuration information bar 207 or a configuration information bar 211 may include the identity of a sending user interface network object, for example, the filter user interface control 202. That is, the configuration information bar 207 may display text such as “receiving filter values from the main page filter”.

In the example shown, the rendered markup language document 122 is configured such that the filter user interface control 202 sends filter values to the data display user interface control from a first developer 209 and the data display user interface control from a second developer 212 as represented by the corresponding network object connection 270. The data display object from a first developer 255 may implement or consume a data access interface 250 such that the data display object from a first developer 255 may retrieve and display data from a remote data source. The data display object from a second developer 260 may implement or consume a similar data access interface 265 which may function similarly to that of the data display object from a first developer 255.

The user of the browser application 107 may type a filter value in the filter user interface control 202, select a filter value from the filter values 205, or the like, then press the apply button user interface control 112. Each of the data display user interface control from a first developer 209 and the data display user interface control from a second developer 212 may display data filtered according to the current filter value of the filter user interface control 202. For example, the data display user interface control from a first developer 209 may display two columns of numbers with each row representing a pair of numbers. Example rows may include the number “1” in the first column and the number “1” in the second column, the number “2” in the first column and the number “2” in the second column, the number “1” in the first column and the number “3” in the second column, and the number “2” in the first column in the number “4” in the second column.

The example data display object may resemble the following:

| First Column | Second Column |
|---|---|
| 1 | 1 |
| 2 | 2 |
| 1 | 3 |
| 2 | 4 |

Continuing the example, the user may configure an example filter user interface control such that the example filter applies to the example first column of the data display user interface control as discussed above. The user may then enter a value of “1” into the example filter user interface control, click the example apply button, and the example data display user interface control may resemble the following:

| First Column | Second Column |
|---|---|
| 1 | 1 |
| 1 | 3 |

Continuing the example again, the user may then enter a value of “2” into the example filter user interface control, click the example apply button, and the example data display user interface control may resemble the following:

| First Column | Second Column |
|---|---|
| 2 | 2 |
| 2 | 4 |

Other example filter user interface controls and example data display user interface controls may include more complex functionality. For example, the above example filter user interface control may be known as a text filter as it accepts user input in the form of text. Another example filter user interface control may be a data filter such that the user is presented with a calendar user interface control from which they may select a date. In the example filter user interface discussed for the filter user interface control 202 and the filter values 205, the filter user interface control may be a list created by a user.

Other example filter user interface controls may make use of data access functionality that may be provided by the server PC 127, the internet server 128, the specialized content handling services 131, or the like. For example, if the specialized content handling services 131 is Microsoft Sharepoint Services®, the example filter user interface control may receive a list of values from Microsoft Sharepoint Services®.

Example filter user interface controls are not limited in the complexity of the data that may be filtered. For example, an example filter user interface object may consume data access services such that the example filter user interface object may interact with an example instance of a Microsoft SQL Server and an example Analysis Services service associated with the example instance of Microsoft SQL Server. Such an example filter user interface control may retrieve a list, a set of lists, or the like from the example instance of Microsoft SQL Server and the example instance of Microsoft SQL Server Analysis Services. More particularly, the example data display user interface control may retrieve data from an example instance of Microsoft SQL Server and the example filter user interface control may retrieve an example corresponding set of values from the same example instance of Microsoft SQL Server.

Additional example filter user interface controls may be implemented in the example network objects framework 215. For example, an author may include a filter user interface control in an example markup language document that does not require the input or interaction of a user. Such an example filter user interface control may not include or display a user interface. Such an example user interface control may be called an automatic filter.

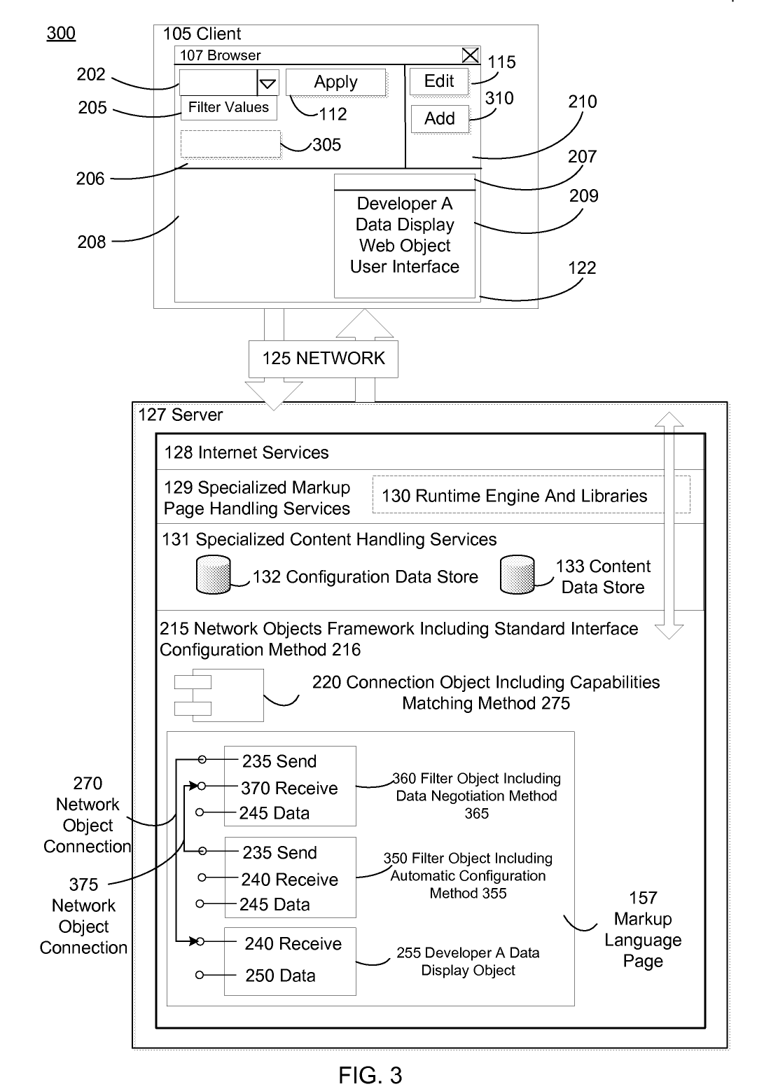

FIG. 3 is a block diagram showing a client PC 105 connected to a server PC 127 by a network, the client PC 105 executing a browser application 107 and the server PC 127 executing an internet server 128, specialized markup language page handling services 129, specialized content handling services 131, and a network objects framework 215. The network objects framework 215 may include a connection object 220 and an alternative set of server-side executable objects consuming standard interfaces.

Such a network objects framework 215 may include classes or objects from which a filter object 360 including a data negotiation method 365, a filter object 350 including an automatic configuration method 355, or the like may be created.

The components having like numbering from the previous figure function similarly, and the reader is directed to the previous figure for a description of their operation. A description of the newly introduced components is provided below.

As discussed in FIG. 2, example filter user interface controls and their corresponding example server-side objects or objects may implement complex functionality. For example, an example filter user interface control may be created such that the example filter user interface control automatically sends at least one filter value to any example data display user interface controls which are configured to receive filter values from the example filter user interface control. Further, example user interface controls may be implemented such that an example user interface control automatically sends a value and may not require user interaction in order to function, and in this example may not display a user interface.

For example, an automatic filter user interface control 305 and its corresponding server-side filter object 360 may or may not display a user interface. In addition, the author of the markup language document 157 may have created the markup language document 157 such that the filter user interface control 202 may be configured to receive information over a standard receive interface 370 from the automatic filter user interface control 305, as represented by the network object connection 375.

Such functionality may allow an example filter user interface control that automatically retrieves the name identifier, electronic identity information, or the like for a user of the client PC 105. Such an example filter user interface control may retrieve an electronic identity from the local operating system or may retrieve electronic identity information from the internet server 128, the specialized markup language page handling services 129, the specialized content handling services 131, or the like. In the example where the specialized content handling services 131 is Microsoft Sharepoint Services®, the example filter user interface control may retrieve extended information corresponding to the current user, for example, a business cost center.

In an alternative example, an example filter user interface control and the example server-side network object corresponding to the example filter user interface control may parse the query string passed to the server PC 127. More particularly, when the browser application 107 sends a hypertext transfer protocol (HTTP) request to the server PC 127, the browser application 107 may generate a query string which may be sent to the server PC 127. Such a query string may include commands that may be executed by the server PC 127. However, not all data display network objects executing on the server PC 127 may understand a command sent in this manner. The example query string filter user interface control and the corresponding server-side query string filter network object may further parse the query string and may send a correct value to a consuming example data display user interface and the corresponding server-side example data display network object.

In another alternative example, an example user interface control may automatically filter the example data display user interface controls using information taken from an example specialized content handling services 131. For example, an author of an example set of markup language documents stored in specialized content handling services 131 may add data describing the general subject area of the example markup language documents. The author may then add an example page field filter user interface control to the example markup language documents and configure the example page field filter user interface control. Such an example page field filter user interface control may then automatically filter all example data display user interface controls such that the content of the page is automatically filtered and may be specific to one subject area drawn from the original general subject area.

In addition, an add filter button 310 that may allow a user to add example filter user interface controls to the page may be included in the markup language document 157. Such an add filter button 310 may appear in the browser application 107 when the rendered markup language document 122 is rendered. The add filter button 310 may function in conjunction with the connection object 220 to present a user interface to the user such that the user may add example filter user interface controls, example data display user interface controls, and the like. Such a user interface may aid the user in selecting appropriate example filter user interface controls, example data display user interface controls, and the like for an example zone in an example markup language document. For example, a user may click an example add filter button included in an example filter zone included in an example markup language document. The example user interface presented to the user may only include example filter user interface controls for inclusion in the configured example markup language document.

FIG. 4 is a flow diagram showing an example method sending a page including configured network objects to a client. Such a method may further include a method for configuring a connection between a filter object and filter consumer object. As previously discussed, the standard interface configuration method 216 (from FIG. 2) may be implemented in a network objects framework 215 (from FIG. 2). The network objects framework 215 (from FIG. 2) may typically be a software service including one or more computer-executable software objects, but such a standard interface configuration method 216 may be equivalently implemented in any type of consumer electronics device which includes a processor and memory.

Block 410 may refer to an operation in which a request is received to send a markup language document identified by a uniform resource locator (URL) to a client.

Block 420 may refer to an operation in which the internet server retrieves configuration information related to the markup language document. Such configuration information may include server-side network object configuration data which may be indexed according to a user's identity.

Block 430 may refer to an operation in which server-side network objects may be instantiated in memory. Any connections between the instantiated network objects may be configured using the connection information retrieved in block 420.

Block 440 may refer to an operation in which the send interface and receive interface of at least one sending network object may be examined and may be identified. A collection of connection objects may be examined and a connection object that may implement the identified send interface and the identified receive interface may be selected. Such a matching of the identified send interface and the identified receive interface may be an exact match or a match determined by any other acceptable criteria.

Block 450 may refer to an operation in which the connection object selected at block 440 may be instantiated.

Block 460 may refer to an operation in which connection between the at least one sending network object, the instantiated connection object, and the at least one receiving network object may be configured. Such a configuration may take the form of redirecting a code pointer, other reference, or the like, on any of the at least one sending network object, the instantiated connection object, the at least one receiving network object, or the like. However, any operation performed by the internet server that facilitates communication between the at least one sending network object, the instantiated connection object, the at least one receiving network object, and the like may be used.

Block 470 may refer to an operation in which the markup language document resulting from the processing performed in the blocks discussed earlier is sent to the client. Such a markup language document may include other instructions, markup language, or the like created during other processing on the internet server.

Such a connection object may further function in conjunction with the internet server to provide a user interface such that a user of the at least one sending network object and the at least one receiving network object may configure the interaction between the at least one sending network object and the at least one receiving network object. Such a configuration method may include a capabilities matching method 275.

FIG. 5 is a flow diagram showing an example configuration method. Such an example configuration method may configure a connection between an example sending network object and an example receiving network object. Such a configuration method may further include a method for matching and managing the capabilities of the example sending network object and the example receiving network object.

As previously discussed, the capabilities matching method 275 (from FIG. 2) may be implemented in a connection object 220 (from FIG. 2). The connection object 220 may typically be a software object or its equivalent, but such a capabilities matching method 275 may be equivalently implemented in any type of consumer electronics device which includes a processor and memory. If the connection object 220 is executed in a PC environment with an operating system, the connection object 220 typically implements a standard interface expected by the operating system. Such a standard interface may allow the operating system to expose the functionality and may allow reuse of the connection object 220 to other objects and applications which may execute in the operating system.

Block 510 may refer to an operation in which a request to configure the connection between a sending network object and a receiving network object is received.

Block 520 may refer to a decision in which it is determined if the receiving network object consumes an interface which supports a multiple value sending interface. A receiving network object may expect to receive only a single value from the sending network object. However, the sending object may send more than a single value to the receiving network object; for example, the sending network object may send a number of values in a comma-delimited list. Flow continues to block 540 in response to a positive determination. Flow continues to block 520 in response to a negative determination.

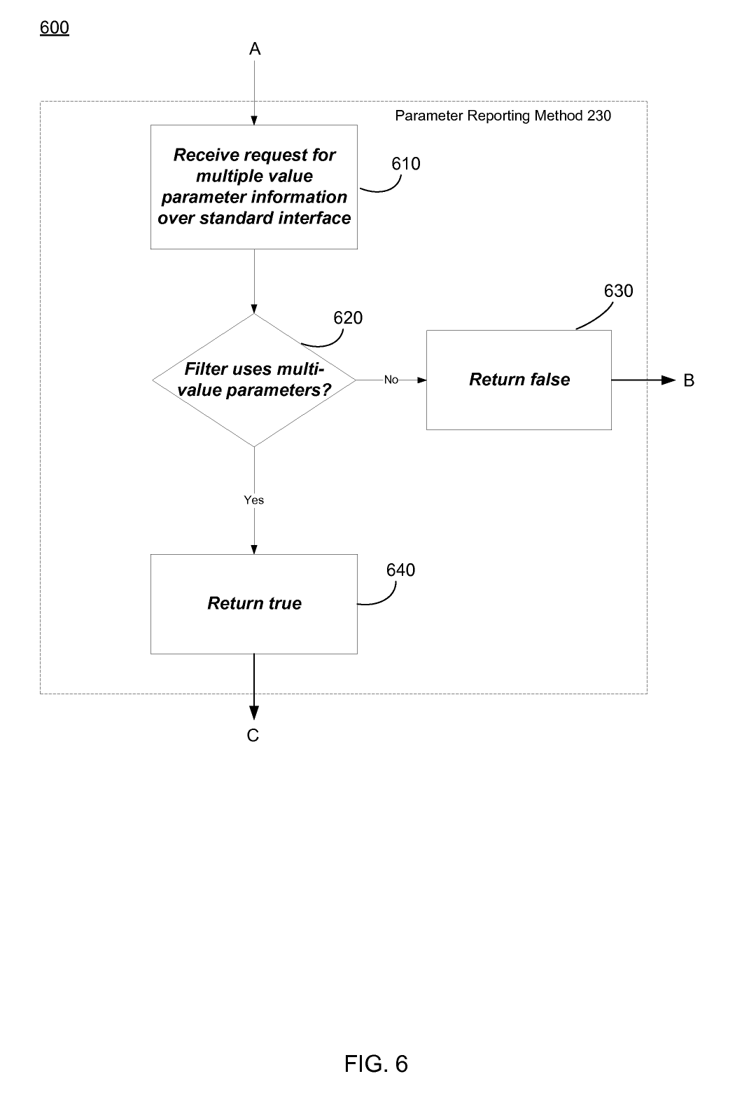

Block 520 may refer to decision in which it is determined if the sending network object sends a multiple value. Such a decision will be discussed4 more fully in the discussion of FIG. 6. Flow continues to block 530 in response to a positive determination. Flow continues to block 540 in response to a negative determination.

Block 530 may refer to an operation in which a property or other indication included on the receiving network object that may indicate the receiving network object is accessible to a user is overridden such that the property or other indication always returns a false value, a value indicating the receiving network object is disabled, or the like. Flow continues on to block 550.

Block 550 may refer to an operation in which the user interface discussed in block 510 informs the user that the sending network object and the receiving network object may not be compatible. Such an informing operation may take the form of an explicit text message but may also be in the form of not showing the receiving network object as a potential receiver of information sent by the sending network object. Flow continues on to block 560.

Block 540 may refer to an operation in which the user interface discussed in block 510 may present a user interface to configure the information sent by the sending network object to the receiving network object.

As discussed in block 520, a sending network object may report if it sends a multiple value parameter to a receiving network object. Such a reporting may be a parameter reporting method 230.

FIG. 6 is a flow diagram showing an example sending network object reporting method in which the example sending network object supports at least one multiple value parameter. As previously discussed, the parameter reporting method 230 (from FIG. 2) may be implemented in a filter network object 225 (from FIG. 2).

The example sending network object may typically be a software object or its equivalent, but such a parameter reporting method 230 may be equivalently implemented in any type of consumer electronics device which includes a processor and memory. If the example sending network object is executed in a PC environment with an operating system, the example sending network object typically implements a standard interface expected by the operating system. Such a standard interface may allow the operating system to expose the functionality and may allow reuse of the example sending network object to other objects and applications which may execute in the operating system.

Block 610 may refer to an operation in which a request is received to evaluate the multiple value parameter capabilities over a standard communication interface. Such an evaluation request may take the form of a method call, a request to get a property value, or the like. Flow continues to block 620.

Block 620 may refer to a decision to determine if multiple value parameters are supported. Flow continues to block 640 in response to a positive determination. Flow continues to block 630 in response to a negative determination.

Block 630 may refer to an operation in which it has been determined that multiple value parameters are not supported and a false value is returned. Such a return may in the form of a return value from a function or the returning of a false value in response to a request to get a property value representing the multiple value support.

Block 640 may refer to an operation in which it has been determined that multiple value parameters are supported and a true value is returned. Such a return may in the form of a return value from a function or the returning of a true value in response to a request to get a property value representing the multiple value support.

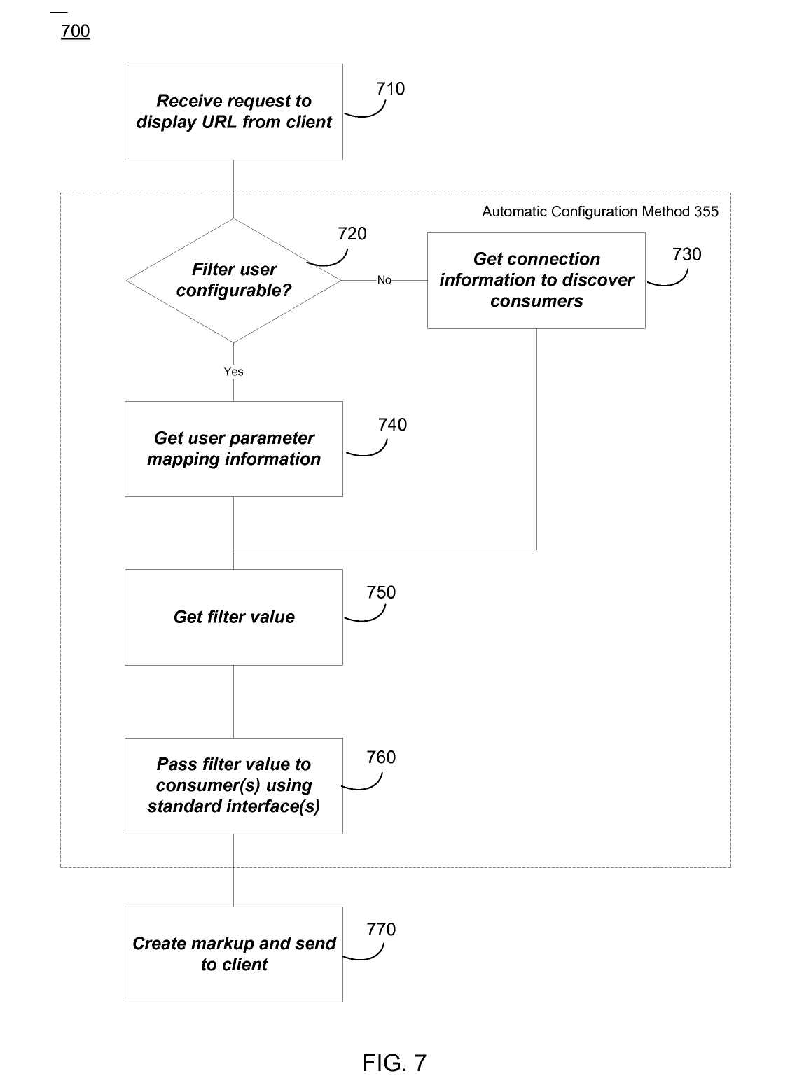

FIG. 7 is a flow diagram showing a method to automatically configure at least one connection within an example network objects framework. As previously discussed, the automatic configuration method 355 (from FIG. 3) may be implemented in a filter object 350 (from FIG. 3). The filter object 350 may typically be a software object or its equivalent, but such an automatic configuration method 355 may be equivalently implemented in any type of consumer electronics device which includes a processor and memory. If the filter object 350 is executed in a PC environment with an operating system, the filter object 350 typically implements a standard interface expected by the operating system. Such a standard interface may allow the operating system to expose the functionality and may allow reuse of the filter object 350 to other objects and applications which may execute in the operating system.

Block 710 may refer to an operation in which a request is received to send a markup language document identified by a uniform resource locator (URL) to a client.

Block 720 may refer to a decision to determine whether a sending network object referenced in the markup language document is configurable by a user. Such information regarding configurability may be received from the sending network object either by a return value from a method or the enumeration of a property included in the sending network object. Flow continues to block 730 in response to a negative determination. Flow continues to block 740 in response to a positive determination.

Block 730 may refer to an operation in which connection information for the sending network object is retrieved from data storage where it may be stored. Such configuration information may be stored in a database, a file containing configuration information, or the like. For example, such configuration information may include data representing a connection between an example sending network object and an example receiving network object. Flow continues to block 750.

Block 740 may refer to an operation to retrieve parameter mapping information, for example the mapping of a sending parameter named on the sending network object to a named receiving parameter on a receiving network object. Flow continues to block 750.

Block 750 may refer to an operation to retrieve a filter value for the sending network object. Such a filter value may be retrieved using any typical data access method. For example, the filter value may be retrieved from the same data source from which an example receiving network object also retrieves data. Flow continues on to block 760.

Block 760 may refer to an operation in which the sending network object sends the filter value retrieved at block 750 to the receiving network object over a standard communication interface. The sending network object and the receiving network object may have been configured at block 730, or in an alternative example, one of a category of a sending network object may send values to any receiving network object of the same category. Flow continues to block 770.

Block 770 may refer to an operation in which the markup language document resulting from the processing performed in the blocks discussed earlier is sent to the client. Such a markup language document may include other instructions, markup language, or the like created during other processing on the internet server.

Methods and procedures for the connection of server-side filter provider objects and server-side filter consumer objects using standard interfaces and additional functionality which may be allowed by the use of standard interfaces are disclosed. Those skilled in the art will realize that storage devices utilized to store program instructions can be distributed across a network. For example, a remote computer may store an example of the process described as software. A local or terminal computer may access the remote computer and download a part or all of the software to run the program.

Alternatively, the local computer may download pieces of the software as needed, or may distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A filter object executable in a computing device, comprising:
a standard sending interface consumed from an object framework to send at least one filter value to at least one consumer object supported by the object framework; and
a user interface to allow a user to configure a connection over the standard sending interface between the filter object and the at least one consumer object.

2. The filter object of claim 1, further comprising a user interface to allow a user to enter a filter value.

3. The filter object of claim 1, further comprising a standard receiving interface to receive at least one filter value.

4. The filter object of claim 1, wherein the filter object sends a single value to the at least one consumer object.

5. The filter object of claim 1, wherein the filter object sends a list of values to the at least one consumer object.

6. The filter object of claim 1, further comprising a field storing a parameter name.

7. The filter object of claim 1, further comprising at least one method to receive the at least one filter value from a data source.

8. The filter object of claim 1, further comprising at least one method to automatically configure the connection between the filter object and the at least one consumer object over the standard sending interface.

9. The filter object of claim 1, further comprising at least one method to receive the filter value from a data source.

10. The filter object of claim 1, further comprising at least one method to receive a database connection string.

11. The filter object of claim 1, wherein the at least one filter value is a predetermined default value.

12. A computer implemented method, comprising:
determining if a filter object implements at least one standard interface that automatically configures the filter object;
receiving configuration information from a specialized content management service in response to a positive determination;
configuring the filter using the configuration information; and
retrieving at least one filter value from the specialized content management service.

13. The computer implemented method of claim 12, wherein the filter object is a page field filter.

14. The computer implemented method of claim 12, wherein the configuration information maps a parameter name to at least one consumer object in communication with the filter object.

15. The computer implemented method of claim 12, wherein the at least one filter value corresponds to a field in a page template stored in the specialized content management service.

16. The computer implemented method of claim 12, wherein the at least one filter value corresponds to at least one piece of data related to a category of markup page types stored in the specialized content management service.

17. At least one computer-readable medium having one or more executable instructions that, when read, cause one or more processors to:
retrieve information using a standard communication interface that relates a parameter name to at least one consumer object;
retrieve information entered by a user; and
send the information entered by a user to the at least one consumer object using a standard communication interface.

18. The at least one computer-readable medium of claim 17, further comprising one or more instructions to cause the one or more processors to provide at least one value that relates to a markup page category.

19. The at least one computer-readable medium of claim 17, wherein the information entered by the user is a list of values.

20. The at least one computer-readable medium of claim 17, further comprising one or more instructions to cause the one or more processors to provide a user interface which allows the user to select a date.
